(19) United States
(12) Patent Application Publication
(10) Pub. No.: US 2010/0008102 A1
(43) Pub. Date: Jan. 14, 2010

(54) BACK LIGHT MODULE

(75) Inventors: Wen-Yi Huang, Taichung County (TW); Chao-Hsiang Chiang, Taichung County (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(73) Assignee: WINTEK CORPORATION, Taichung (TW)

(21) Appl. No.: 12/500,612

(22) Filed: Jul. 10, 2009

(30) Foreign Application Priority Data
Jul. 14, 2008 (TW) 97126669

(51) Int. Cl. F21V 8/00; G02F 1/13357

(52) U.S. Cl. 362/612; 362/611; 362/633

(57) ABSTRACT

A back light module including a light-guiding plate and a point light source is provided. The light-guiding plate has a first light emitting surface and a light receiving surface adjacent to the first light emitting surface. The point light source has a package housing, and the package housing is tightly bonded with the light receiving surface of the light-guiding plate to form a welding interface. The above back light module achieves a desirable light-output efficiency.

### CROSS-REFERENCE TO RELATED APPLICATION

This application claims the priority benefit of Taiwan application serial no. 97126669, filed on Jul. 14, 2008. The entirety of the above-mentioned patent application is hereby incorporated by reference herein and made a part of specification.

### BACKGROUND OF THE INVENTION

1. Field of the Invention

The present invention relates to a back light module, in particular, to a back light module with a desirable light-output effect.

2. Description of Related Art

With the rapid development of the semiconductor and relevant electronic industry, digital tools such as mobile phones, digital cameras, digital video cameras, notebook computers, and desk-top computers all develop towards the trend of convenience, multifunction, and desirable appearance. However, when these information products are used, display screens are indispensable man-machine communication interfaces. The display screens of the above products can bring more convenience for users' operations. Furthermore, liquid crystal displays have become the mainstream of display screens. Since the liquid crystal display does not possess a light-emitting function, a back light module must be provided below the liquid crystal display for providing a light source, so as to achieve the displaying function.

FIG. 1A is a schematic view of a conventional back light module, and FIG. 1B is an enlarged schematic view of an area A in FIG. 1A. Referring to FIGS. 1A and 1B, a back light module 100 includes a frame 110, a light-guiding plate 120, a plurality of light-emitting diodes (LEDs) 130, and a flexible circuit board 140. The light-guiding plate 120, the LEDs 130, and the flexible circuit board 140 are all snapped into the frame 110. The light-guiding plate 120 has a first light emitting surface 122 and a light receiving surface 124 adjacent to the first light emitting surface 122. The LEDs 130 are disposed on the flexible circuit board 140. Each of the LEDs 130 has a second light emitting surface 132. The second light emitting surface 132 is faced to the light receiving surface 124.

FIG. 1C is a side view of a part of members of the back light module in FIG. 1A. Referring to FIGS. 1B and 1C, in the back light module 100, the position of the light-guiding plate 120 and the LEDs 130 are adjusted according to shapes of the elements. Therefore, under the influences caused by the errors in a positioning process, the light-guiding plate 120 is often spaced apart from the LEDs 130 by a gap T. When the back light module 100 is turned on, light emitted from the LEDs 130 cannot completely enter the light-guiding plate 120 for being used, but a portion of the light, for example the light L) is emitted out via the gap T. In other words, a light leakage occurs in the back light module 100. Therefore, the light utilization rate of the back light module 100 is somewhat limited. What's worse, the portion of light L emitted out via the gap T may form a beam or halo, and thus, the light-output quality of the back light module 100 is deteriorated.

### SUMMARY OF THE INVENTION

Accordingly, the present invention is directed to a back light module, which is suitable for solving the problem of a poor light-output effect of a conventional back light module.

A back light module is provided in the present invention, which includes a light-guiding plate and a point light source. The light-guiding plate has a first light emitting surface and a light receiving surface adjacent to the first light emitting surface. The point light source has a package housing, and the package housing is tightly bonded with the light receiving surface of the light-guiding plate to form a welding interface. The light-guiding plate may includes one or multiple diffusion structures (not shown) corresponding to the point light source for diffusing an incident light near the light receiving surface; however, the diffusion structures are not the features of the invention so that they would not be discuss in the invention.

In an embodiment of the present invention, the above package housing is made of Acrylonitrile-Butadiene-Styrene resin (ABS).

In an embodiment of the present invention, the above light-guiding plate is made of polycarbonate (PC) or acrylic.

In an embodiment of the present invention, the above back light module further includes a supporting substrate. The point light source is disposed on the supporting substrate. In an embodiment, the above point light source has a second light emitting surface and a bottom surface adjacent to the second light emitting surface. The bottom surface is connected to the supporting substrate, and the second light emitting surface is connected to the light receiving surface. In this case, the supporting substrate is, for example, a flexible circuit board. In other embodiments, the second light emitting surface and the bottom surface are opposite to each other. In addition, the bottom surface is connected to the supporting substrate, and the second light emitting surface is connected to the light receiving surface. The supporting substrate is, for example, a printed circuit board (PCB).

In an embodiment of the present invention, the above back light module further includes a frame. The point light source and the light-guiding plate are snapped into the frame.

In an embodiment of the present invention, the above point light source is, for example, a light-emitting diode (LED).

In an embodiment of the present invention, the above package housing is tightly bonded with the light receiving surface of the light-guiding plate through ultrasonic welding.

In the present invention, since the point light source is tightly bonded with the light-guiding plate, no gap is formed between the point light source and the light-guiding plate. When the back light module of the present invention is turned on, light emitted from the point light source can completely enter the light-guiding plate, thus enhancing the light utilization rate of the back light module. Moreover, no light leakage occurs between the point light source and the light-guiding plate of the present invention, which enables the back light module to have a desirable light-output effect.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1A is a schematic view of a conventional back light module.

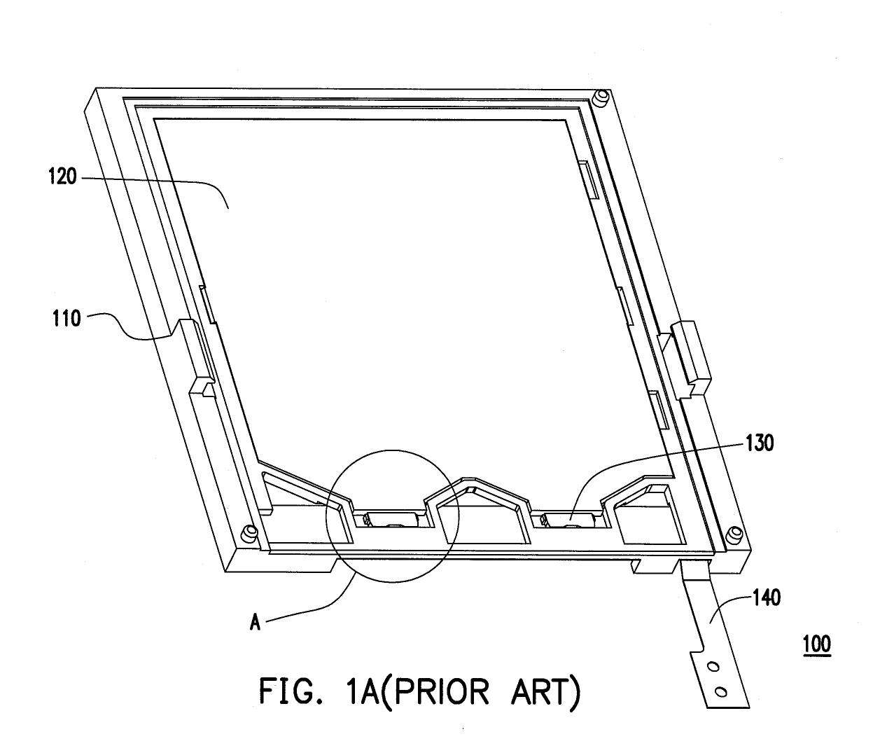

FIG. 1B is an enlarged schematic view of an area A in FIG. A.

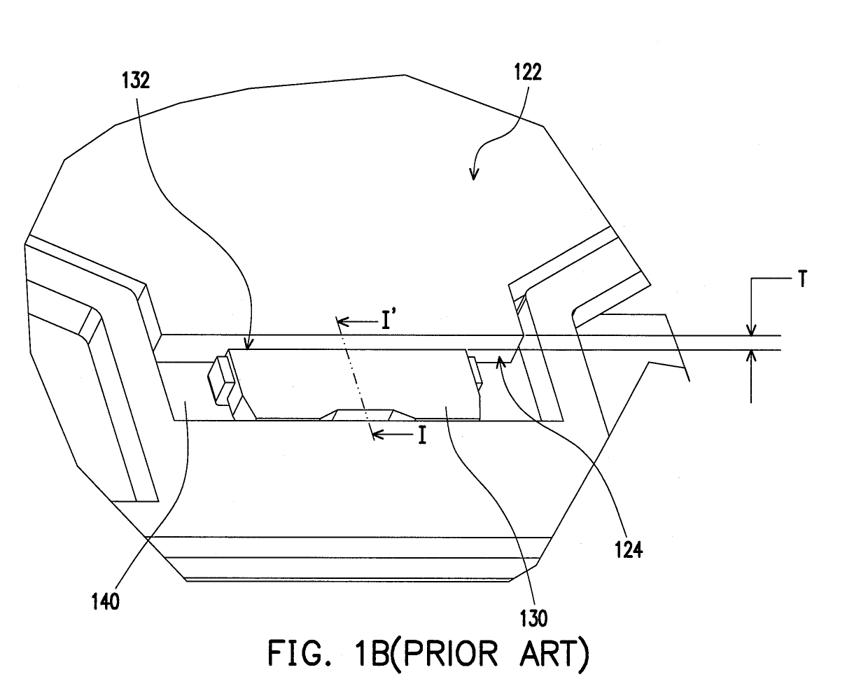

FIG. 1C is a schematic side view of a part of members of the back light module in FIG. A.

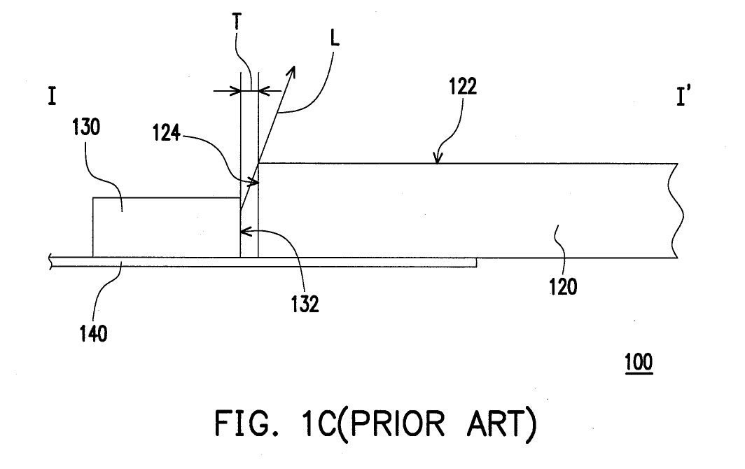

FIG. 2A shows a back light module according to an embodiment of the present invention.

FIG. 2B is an enlarged schematic view of an area B in FIG. 2A.

FIG. 2C is a schematic side view of a part of members of a back light module according to an embodiment of the present invention.

FIG. 3 is a schematic side view of a part of members of a back light module according to another embodiment of the present invention.

### DESCRIPTION OF THE EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

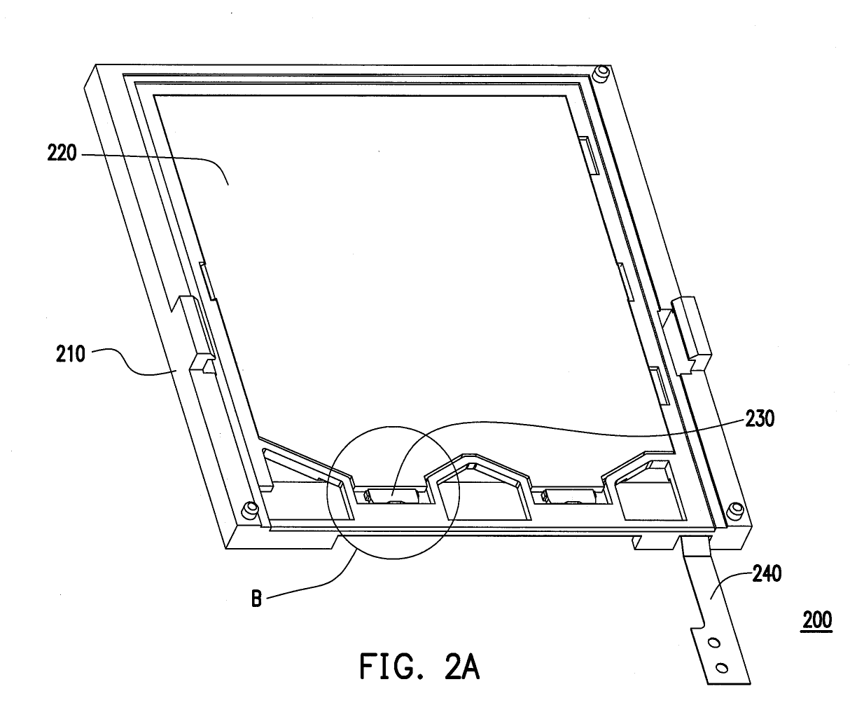

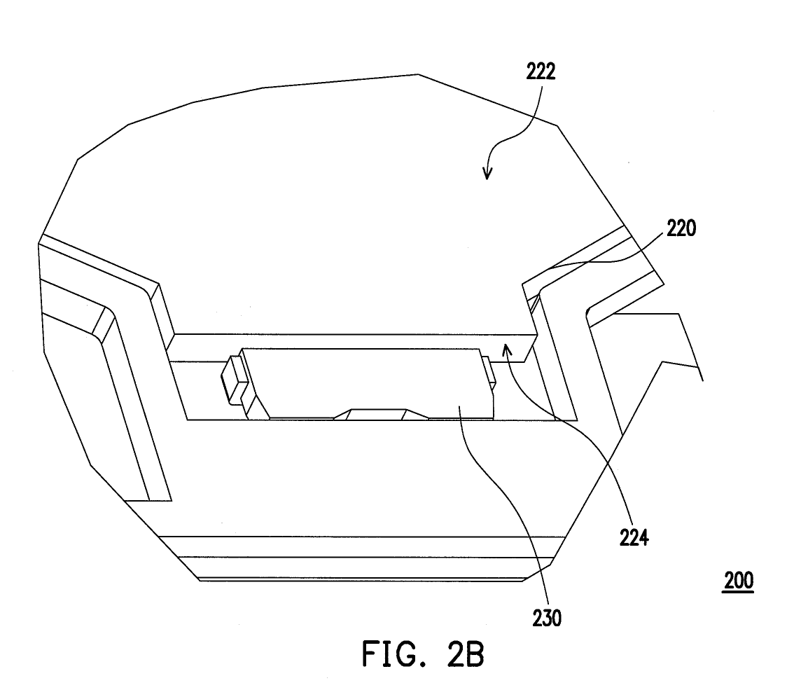

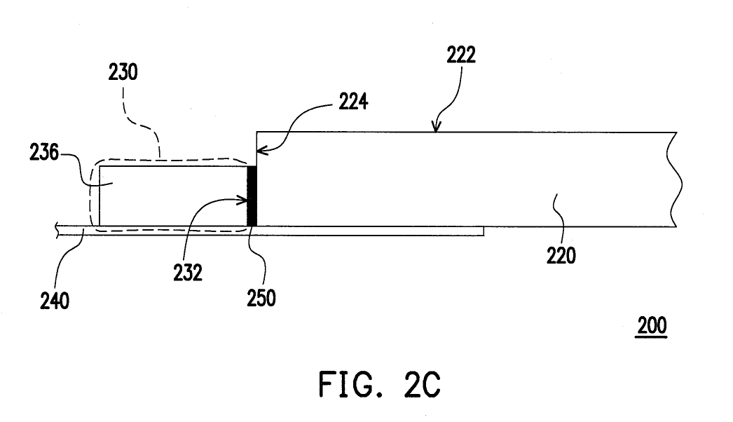

FIG. 2A shows a back light module according to an embodiment of the present invention, and FIG. 2B is an enlarged schematic view of an area B in FIG. 2A. Referring to FIGS. 2A and 2B, a back light module 200 includes a frame 210, a light-guiding plate 220, a plurality of point light sources 230, and a supporting substrate 240. The point light sources 230, the light-guiding plate 220, and the supporting substrate 240 are, for example, snapped into the frame 210. In this embodiment, the profile designs of the frame 210, the light-guiding plate 220, and the point light sources 230 are merely intended for illustration, but not to limit the present invention.

The light-guiding plate 220 has a first light emitting surface 222 and a light receiving surface 224 adjacent to the first light emitting surface 222. The plurality of point light sources 230 is tightly bonded to the light receiving surface 224 of the light-guiding plate. The point light sources 230 are, for example, a plurality of light-emitting diodes (LEDs), and are disposed on the supporting substrate 240.

If the point light sources 230 are not tightly bonded to the light-guiding plate 220 (that is, as the design of the back light module 100), a portion of light emitted from the point light sources 230 directly enters the light-guiding plate 220, but the other portion of the light is directly emitted out or absorbed by other elements. The portion of the light that is directly emitted out may be concentrated in a particular direction to form a beam, since they are not subjected to the effect of the light-guiding plate 220. In addition, the portion of the light that is directly emitted out may also form a halo due to the interference with other light. Both the unnecessary beam and halo are main factors that cause the deterioration of the light-output quality of the back light module 100.

Therefore, in this embodiment, the point light sources 230 are tightly bonded to the light-guiding plate 220, such that the light emitted from the point light sources 230 can only be emitted out via the light-guiding plate 220. That is, the light sources provided by the back light module 200 are not easily interfered by other light and thus have desirable quality. Besides, the structure with the point light sources 230 being tightly bonded to the light-guiding plate 220 is also helpful for improving the light utilization rate of the back light module 200.

FIG. 2C is a schematic side view of a part of members of a back light module according to an embodiment of the present invention. In particular, referring to FIG. 2C, each of the point light sources 230 has a second light emitting surface 232 and a bottom surface 234 adjacent to the second light emitting surface 232. The bottom surface 234 is connected to the supporting substrate 240, and the second light emitting surface 232 is connected to the light receiving surface 224. The supporting substrate 240 is, for example, a flexible circuit board.

Since the point light sources 230 in this embodiment are LEDs, each of the point light sources 230 has, for example, a package housing 236. When the back light module 200 is manufactured, in order to avoid an unnecessary gap formed between the point light sources 230 and the light-guiding plate 220 due to errors in the positioning process, the point light sources 230 and the light-guiding plate 220 can be bonded together through ultrasonic welding. The ultrasonic welding herein refers to a bonding process in which two objects in contact with each other are partially melted at the contact surface there-between due to frictional heats generated through high-frequency (like ultrasonic frequency, over 20,000 Hz) micro-amplitude vibrations. The two objects are bonded together upon curing of the melted portion.

Since the point light sources 230 and the light-guiding plate 220 are bonded to each other through ultrasonic welding in this embodiment, the back light module 200 further includes a plurality of welding interfaces 250 between the point light sources 230 and the light-guiding plate 220, so as to enable the point light sources 230 to be tightly bonded to the light-guiding plate 220. On one hand, through ultrasonic welding, the point light sources 230 and the light-guiding plate 220 can be tightly bonded with each other. On the other hand, in terms of the cost of the manufacturing process, the two members can be tightly bonded to each other through ultrasonic welding, without using other adhesives or glues, which is further helpful for reducing the cost required for purchasing the bonding materials. Moreover, in the steps of the ultrasonic welding process, the frictional heats are merely generated close to the contact surface between the two objects, and do not melt other portions of the point light sources 230 or the light-guiding plate 220. Therefore, the point light sources 230 and the light-guiding plate 220 will not be damaged during the ultrasonic welding process, which is helpful for maintaining the yield of the manufacturing process of the back light module 200.

In fact, the ultrasonic welding process is preferably used to bond two materials with similar or same properties. In the back light module 200, the package housing 236 is, for example, made of Acrylonitrile-Butadiene-Styrene resin (ABS), and the light-guiding plate 220 is, for example, made of polycarbonate (PC) or acrylic. For example, the arcrylic material may be polymethyl methacrylate (PMMA). Since the above two materials have similar properties, the light-guiding plate 220 and the point light sources 230 can be tightly bonded together through ultrasonic welding. Moreover, the welding interfaces 250 are formed after the two melted materials are cured, so that the welding interfaces 250 are, for example, made of a mixed material of ABS and PC or a mixed material of PMMA and ABS. It should be understood that, the material of the package housing 236 and the light-guiding plate 220 are not limited to the above materials in the present invention. In other embodiments, the package housing 236 and the light-guiding plate 220 may also be made of other materials in a similar or the same manner. In other words, the welding interfaces 250 may be made of other mixed materials.

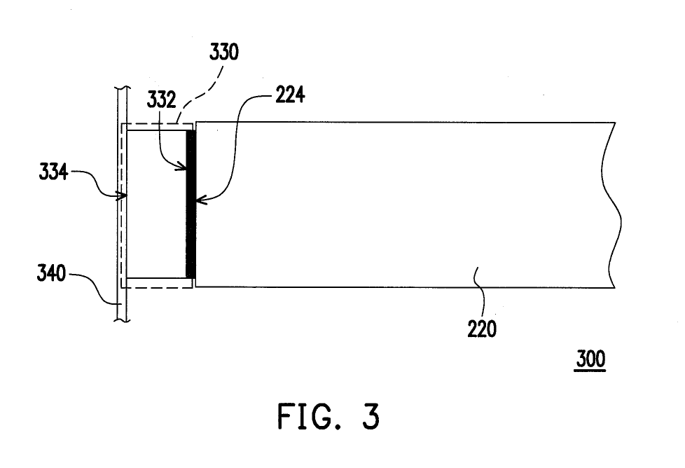

Since the light-guiding plate 220 and the point light sources 230 are tightly bonded to each other through ultrasonic welding in this embodiment, the light emitted from the point light sources 230 do not leak out, which enables the back light module 200 to have a desirable light-output effect. FIG. 3 is a schematic side view of a part of members of a back light module according to another embodiment of the present invention. Referring to FIG. 3, a back light module 300 is similar to the back light module 200, and the difference there-between lies in that, a second light emitting surface 332 and a bottom surface 334 of the point light sources 330 are opposite to each other, the bottom surface 334 is connected to a supporting substrate 340, and the second light emitting surface 332 is connected to a light receiving surface 224. In this case, the supporting substrate 340 is, for example, a printed circuit board (PCB). The point light sources 330 may also be bonded to the light-guiding plate 220 through ultrasonic welding. Hence, the back light module 300 can achieve a desirable light-output effect. Moreover, the back light module 300 also has a desirable light utilization rate.

To sum up, in the back light module of the present invention, the light-guiding plate and the point light sources are tightly bonded together, such that the light leakage via the gap between the point light sources and the light-guiding plate can be eliminated. In particular, the tight bonding between the light-guiding plate and the point light sources can prevent the light emitted from the point light sources from being directly emitted out of the back light module, which improves the light-output effect of the back light module. Moreover, the back light module of the present invention can more effectively utilize the light emitted from the point light sources and thus have a better performance.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A back light module, comprising:
a light-guiding plate, comprising a first light emitting surface and a light receiving surface adjacent to the first light emitting surface; and
a point light source, having a package housing, wherein the package housing is tightly bonded with the light receiving surface of the light-guiding plate to form a welding interface.

2. The back light module according to claim 1, wherein a material of the package housing comprises Acrylonitrile-Butadiene-Styrene resin (ABS resin).

3. The back light module according to claim 1, wherein a material of the light-guiding plate comprises polycarbonate (PC) or acrylic.

4. The back light module according to claim 1, further comprising a supporting substrate, wherein the point light source is disposed on the supporting substrate.

5. The back light module according to claim 4, wherein the point light source comprises a second light emitting surface and a bottom surface adjacent to the second light emitting surface, the bottom surface is connected to the supporting substrate, and the second light emitting surface is connected to the light receiving surface.

6. The back light module according to claim 5, wherein the supporting substrate is a flexible circuit board.

7. The back light module according to claim 4, wherein the point light source comprises a second light emitting surface and a bottom surface opposite to each other, the bottom surface is connected to the supporting substrate, and the second light emitting surface is connected to the light receiving surface.

8. The back light module according to claim 7, wherein the supporting substrate is a printed circuit board (PCB).

9. The back light module according to claim 1, further comprising a frame, wherein the point light source and the light-guiding plate are snapped into the frame.

10. The back light module according to claim 1, wherein the point light source is a light-emitting diode (LED).

11. The back light module according to claim 1, wherein the package housing is tightly bonded with the light receiving surface of the light-guiding plate through ultrasonic welding.
